(19) United States
(12) Patent Application Publication
(10) Pub. No.: US 2016/0023445 A1
(43) Pub. Date: Jan. 28, 2016

(54) A MULTI-LAYER POLYMERIC FILM

(71) Applicant: BILCARE LIMITED, Maharashtra (IN)

(72) Inventors: Sanjeev Dattatray KULKARNI, Pune (IN); Mahendra Mukund UMRANI, Pune (IN); Nikhil Hiraman JADHAV, Pune (IN); Praful NAIK, Pune (IN); Somenath MUKHERJEE, Pune (IN)

(21) Appl. No.: 14/773,729

(22) PCT Filed: Mar. 10, 2014
(86) PCT No.: PCT/IN2014/000157

§ 371 Date: Sep. 8, 2015

(30) Foreign Application Priority Data
Mar. 8, 2013 (IN) 709/MUM/2013

(51) Int. Cl. B32B 27/30; B32B 7/12; B65D 65/40; B65D 75/36; B65D 65/14; B32B 27/32; B32B 37/12

(52) U.S. Cl. CPC B32B 27/304; B32B 27/32; B32B 7/12; B32B 37/12; B65D 75/36; B65D 65/14; B65D 65/40; B32B 2307/7246; B32B 2307/7242; B32B 2307/7244; B32B 2439/70; B32B 2255/10; B32B 2255/26; B32B 2439/80; B65D 2565/387

(57) ABSTRACT

The present disclosure provides a multilayer formable barrier film having a thickness ranging from 100 to 750 micron comprising. The film comprises i) a substrate layer comprising a) a PVC film, optionally laminated with a PE film and, b) at least one layer of PVDC as a barrier layer; and ii) a base layer comprising a) a PVC film, optionally laminated with a PE film and, b) at least one layer of PVDC as a barrier layer, said base layer laminated to said substrate layer through an adhesive coat.

### FIELD OF THE DISCLOSURE

The present disclosure relates to a multilayer polymeric film and its preparation. The present disclosure particularly relates to a multilayer formable barrier film and its preparation.

### INTRODUCTION

The stringent requirements for effective packaging of food, pharmaceuticals and health care products have led to the development and improvement of a wide range of multilayer polymeric films. These films mostly comprise laminates of polymeric film/s such as polycarbonate, polyvinyl chloride (PVC), polyethylene or polyethylene terephthalate along with a gas and liquid-impermeable, moisture resistant barrier layer, such as polyvinylidene chloride (PVDC), ethylene vinyl alcohol (EVOH) or an inorganic material. Typically, the inorganic material used as a barrier layer is aluminum. The barrier films of the afore-stated multilayer polymeric film resist penetration of moisture and atmospheric gases into the product packed therein.

The multilayer film containing a thick layer of aluminum foil as a barrier film (>500 A) are opaque and environmentally unfriendly because they can't be recycled easily. Further, the multilayer film containing a thin layer of barrier film which includes but is not limited to aluminum metal (<100 A), aluminum oxides, and silicon oxides can be transparent; however, their barrier properties deteriorate significantly upon flexing, stretching, forming or abrading.

Among the aforementioned multilayer polymeric films, PVC in combination with PVDC offers a wide range of benefits to the consumer such as product visibility, moisture barrier and mechanical protection. However, there is significant reduction in the barrier properties of these multilayer polymeric films upon blistering by using thermo-forming or cold forming process.

Accordingly, there is felt a need for a multilayer polymeric film which is adapted to maintain its barrier properties upon flexing, stretching or blistering.

### DEFINITION

The term “cold forming process” as used in the context of the present disclosure means a manufacturing process in which material is shaped at ambient temperature to produce material components with a close tolerance and net shape.

The term “thermo forming process” as used in the context of the present disclosure means a manufacturing process for thermoplastic sheet or film wherein plastic sheet or film is converted into a formed, finished part. The sheet or film is heated in an oven to its forming temperature followed by stretching into or onto a mold.

### OBJECT

Some of the objects of the present disclosure, which at least one embodiment herein satisfies, are as follows:

It is an object of the present disclosure to provide a multilayer polymeric film.

It is another object of the present disclosure to provide a multilayer polymeric film which has efficient moisture and gas resistant properties.

It is yet another object of the present disclosure to provide a multilayer polymeric film which is cold formable.

It is still another object of the present disclosure to provide a multilayer polymeric film which is thermo formable.

It is further object of the present disclosure to provide a multilayer polymeric film which is cost effective.

It is still further object of the present disclosure to provide a process for preparing a multilayer formable barrier polymeric film.

An additional object of the present disclosure is to provide a blister pack prepared by using a multilayer formable barrier polymeric film.

Other objects and advantages of the present disclosure will be more apparent from the following description, which are not intended to limit the scope of the present disclosure.

### SUMMARY

In accordance with the present disclosure there is provided a multilayer formable barrier film having a thickness ranging from 100 to 750 micron comprising:
a substrate layer having a thickness ranging from 50 to 500 micron, said substrate layer comprises: i) a polyvinyl chloride (PVC) film having a thickness ranging from 50 to 200 optionally laminated with a polyethylene (PE) film having a thickness ranging from 10 to 100 and ii) at least one poly(vinylidene dichloride)(PVDC) layer having a thickness ranging from 10 to 100 micron; and
a base layer having a thickness ranging from 50 to 250 micron laminated to said substrate layer through an adhesive coat, said base layer comprises i) a polyvinyl chloride (PVC) film having a thickness ranging from 50 to 200 optionally laminated with a polyethylene (PE) film having a thickness ranging from 10 to 100 and ii) at least one poly(vinylidene dichloride)(PVDC) layer having a thickness ranging from 10 to 100 micron.

Typically, said poly(vinylidene dichloride) (PVDC) is selected from the group consisting of regular poly(vinylidene dichloride) (RPPVDC), high barrier poly(vinylidene dichloride) (SBPVDC) and combinations thereof.

Typically, the film exhibits at least one barrier property selected from the group consisting of moisture barrier, oxygen barrier, gas barrier and vapor barrier properties. Typically, the adhesive is selected from the group consisting of polyurethane, acrylic polymer, isocyanides and combinations thereof.

Typically, the film is characterized by WVTR ranging from 0.01 to 0.5 gm/m²/day. In one of the embodiments, the WVTR of the film ranges from 0.04 to 0.15 gm/m²/day.

In accordance with another aspect there is provided a blister package comprising a lid element and a base element sealing securely to each other, said base element is made from the multilayer formable barrier film of the present disclosure, said base element comprises a flat portion and a formed portion.

Typically, the WVTR of the formed portion of said base element ranging from 0.02 to 0.5 gm/m²/day.

In accordance with another aspect there is provided a process for the preparation of a multilayer formable barrier film having a thickness in the range of 100 to 750 micron; said process comprises the following steps:
providing a substrate layer of thickness 50 to 500 micron by coating a polyvinyl chloride (PVC) film of thickness ranging from 50 to 200 with at least one layer of poly(vinylidene dichloride)(PVDC) of thickness ranging from 10 to 100 micron using an adhesive coat having a thickness ranging from 0.1 to 10 micron,
obtaining a base layer of thickness 50 to 250 micron by coating a (polyvinyl chloride) PVC film of thickness ranging from 50 to 200 with at least one layer of poly(vinylidene dichloride)(PVDC) of thickness ranging from 10 to 100 micron using an adhesive coat having a thickness ranging from 0.1 to 10 micron, and
laminating said substrate layer and said base layer using an adhesive coat having a thickness ranging from 0.1 to 10 micron multilayer formable barrier film.

Typically, the process includes a step of laminating the polyvinyl chloride (PVC) film with a polyethylene (PE) film using an adhesive coat before coating said PVC film with the PVDC layer.

### BRIEF DESCRIPTION OF ACCOMPANYING DRAWINGS

The present disclosure is explained with accompanying drawings wherein:

FIG. 1 illustrates multi-layer formable film (C) prepared in accordance with example 1, wherein A] represents a substrate layer and B] represents a base layer; and

FIG. 2 illustrates multi-layer formable film (C) prepared in accordance with example 7, wherein A] represents a substrate layer and B] represents a base layer.

### DETAILED DESCRIPTION

The present disclosure provides a packaging film having desired strength properties and barrier properties which can be used for packaging pharmaceutical products, nutraceuticals, food products and the like. Particularly, the present disclosure provides a multilayered film which can provide protection to the product packed therein from oxygen in the air and/or moisture. Further, the present disclosure provides a multilayered film that can be thermo/cold-formed and retain the desired barrier properties after thermorforming into blister/cavity/pouch. Still further, the present disclosure provides a multilayered film which when cold/thermo-formed into blister/cavity/pouch provides desired transparency for the detection of product filled in the pack either by manually or by online NFD without affecting the barrier property.

Accordingly, the present disclosure provides a multilayer formable barrier film having a thickness ranging from 100 to 750 micron. The film mainly consists of a substrate layer having a thickness ranging from 50 to 500 micron and a base layer having, a thickness ranging from 50 to 250 micron which is laminated to the substrate layer.

The substrate layer is made up of one or more polymer film/s and one or more barrier layer/s which is/are coated to the polymer film through the use of an adhesive coat. The barrier layer in the substrate layer of the present disclosure is poly(vinylidene dichloride) (PVDC). The thickness of the PVDC layer ranged from 10 to 100 micron. The polymer film used in the substrate layer of the present disclosure is a polyvinyl chloride (PVC) film. Alternatively, a combination of a polyvinyl chloride (PVC) film and polyethylene (PE) film is utilized as a polymer film. i.e. a PVC film is first laminated by a PE film and then it is coated with a PVDC layer.

The thickness of the PVC film ranges from 50 to 200 micron (μm), whereas the thickness of the PE film ranges from 10 to 100 micron. The thickness of the adhesive coat can be 0.1 to 10 micron.

The base layer is also made up of one or more polymer film/s having a thickness ranging from 50 to 200 and one or more barrier layer/s having a thickness ranging from 10 to 100 micron which is coated to polymer film through the use of an adhesive coat having a thickness ranging from 0.1 to 10 micron.

The barrier layer employed in the base layer of the present disclosure is poly(vinylidene dichloride) (PVDC). The thickness of the PVDC layer ranged from 10 to 100 micron.

The polymer film used in the base layer of the present disclosure is a polyvinyl chloride (PVC) film. Alternatively, a combination of a polyvinyl chloride (PVC) film and polyethylene (PE) film is utilized as a polymer film. i.e. a PVC film is first laminated by a PE film and then it is coated with a PVDC layer. The thickness of the PVC film ranges from 50 to 200 micron (μm), whereas the thickness of the PE film ranges from 10 to 100 micron. The thickness of the adhesive coat can be 0.1 to 10 micron.

The adhesive employed for the lamination includes but is not limited to polyurethane, acrylic polymer, isocyanides and combinations thereof.

The WVTR (water vapor transmission rate) of the film prepared as per the present disclosure is found to be 0.01 to 0.5 gm/m²/day. In one of the preferred embodiments, the WVTR ranges from 0.04 to 0.15 gm/m²/day.

Thus, the film prepared as per the present disclosure exhibits at least one barrier property selected from the group consisting of moisture barrier, oxygen barrier, gas barrier and vapor barrier properties.

In accordance with another aspect of the present disclosure there is also provided a blister package. The blister package mainly consists of a lid element and a base element sealing securely to each other. The base element is made from the multilayer formable barrier film of the present disclosure. The base element mainly consists of a flat portion and a formed portion (blister/cavity). The WVTR (water vapor transmission rate) of the formed portion of the base element ranging from 0.02 to 0.5 gm/m²/day. In one of the preferred embodiments, the WVTR ranges from 0.05 to 0.5 gm/m²/day.

In accordance with still another aspect of the present disclosure there is provided a process for the preparation of a multilayer formable barrier film having a thickness in the range of 100 to 750 micron. The process is described herein below.

In the first step, a substrate layer of thickness 50 to 500 micron is provided/prepared by coating a polyvinyl chloride (PVC) film of thickness ranging from 50 to 200 with at least one layer of poly(vinylidene dichloride) (PVDC) of thickness ranging from 10 to 100 micron using an adhesive coat having a thickness ranging from 0.1 to 10 micron.

In the second step, a base layer of thickness 50 to 250 micron is obtained by coating a polyvinyl chloride (PVC) film of thickness ranging from 50 to 200 with at least one layer of poly(vinylidene dichloride) (PVDC) of thickness ranging from 10 to 100 micron using an adhesive coat of thickness ranging from 0.1 to 10 micron.

Finally, the substrate layer and the base layer are laminated together using an adhesive coat of thickness ranging from 0.1 to 10 micron.

The process further includes a step of laminating the polyvinyl chloride (PVC) film with a polyethylene (PE) film. The poly(vinylidene dichloride) (PVDC) is then coated onto the PE film laminated on PVC film.

The present disclosure is further described in light of the following examples which are set forth for illustration purpose only and not to be construed for limiting the scope of the disclosure.

### EXAMPLES

### Procedure

Initially, a substrate layer was prepared by coating a PVC film with a PVDC through an adhesive. Alternatively, a substrate layer was prepared by first laminating a PVC film with a PE film followed by coating with a PVDC film through an adhesive. Similar to the substrate layer, a base layer was prepared.

In the next step, the substrate layer and/or the base layer were coated with an adhesive and then both the layers were subjected to lamination by passing through counter rotating rollers at a temperature ranging from 50 to 55° C. and at a pressure of 6 kg/m² to obtain a multilayered barrier film or laminate.

The obtained films were then subjected to thermoforming procedure to obtain blisters/cavities. The films as well as the thermoformed blisters were tested for the barrier properties. Size of the blister/cavity: “0” capsule size/“6.4” tablet size.

### Examples 1-35

The multilayer formable barrier films and blisters/cavities therefrom were prepared using particulars provided in the following table and the procedure described herein above.

TABLE 1

| | | | Characteristics | Characteristics |
|---|---|---|---|---|
| Example | Substrate | | of the thermo- | of the thermo- |
| No. | layer | Base layer | formable film | formed blister |
| 1. | PVC*: 130 μm | PVC*: 120 μm | Dimensional stability %: | WVTR (38° C. % 90% Rh) |
| | PE: 25 μm | PVDC: 60 gsm | Longitudinal: −3 | gm/m²/day: 0.09 |
| | PVDC: 80 gsm | | Transverse: +1 | |
| | | | Tensile strength kg/cm2 | |
| | | | MD: 427 | |
| | | | TD: 442 | |
| | | | Impact strength gsm: 500 | |
| | | | WVTR (38° C. 90% Rh) | |
| | | | gm/m²/day: 0.0804 | |
| 2. | PVC*: 130 μm | PVC′: 120 μm | Dimensional stability %: | WVTR (38° C. % 90% Rh) |
| | PE: 25 μm | PVDC: 60 gsm | Longitudinal: −2.5 | gm/m²/day: 0.09 |
| | PVDC: 80 gsm | | Transverse: +1 | |
| | | | Tensile strength kg/cm2 | |
| | | | MD: 449 | |
| | | | TD: 428 | |
| | | | Impact strength gsm: 680 | |
| | | | WVTR (38° C. % 90% Rh) | |
| | | | gm/m²/day: 0.0665 | |
| 3. | PVC*: 130 μm | PVC*: 120 μm | Dimensional stability %: | WVTR (38° C. % 90% Rh) |
| | PE: 25 μm | PVDC: 80 gsm | Longitudinal: −2 | gm/m²/day: 0.08 |
| | PVDC: 80 gsm | | Transverse: +1.5 | |
| | | | Tensile strength kg/cm2 | |
| | | | MD: 468 | |
| | | | TD: 449 | |
| | | | Impact strength gsm: 410 | |
| | | | WVTR (38° C. 90% Rh) | |
| | | | gm/m²/day: 0.0643 | |
| 4. | PVC*: 130 μm | PVC′: 120 μm | Dimensional stability %: | WVTR (38° C. % 90% Rh) |
| | PE: 25 μm | PVDC: 80 gsm | Longitudinal: −3 | gm/m²/day: 0.08 |
| | PVDC: 80 gsm | | Transverse: +1 | |
| | | | Tensile strength kg/cm2 | |
| | | | MD: 430 | |
| | | | TD: 444 | |
| | | | Impact strength gsm: 410 | |
| | | | WVTR (38° C. % 90% Rh) | |
| | | | gm/m²/day: 0.0712 | |
| 5. | PVC*: 120 μm | PVC*: 120 μm | Dimensional stability %: | WVTR (38° C. % 90% Rh) |
| | PVDC: 100 gsm | PVDC: 100 gsm | Longitudinal: −3 | gm/m²/day: 0.07 |
| | | | Transverse: +1 | |
| | | | Tensile strength kg/cm2 | |
| | | | MD: 429 | |
| | | | TD: 408 | |
| | | | Impact strength gsm: 410 | |
| | | | WVTR (38° C. 90% Rh) | |
| | | | gm/m²/day: 0.0467 | |
| 6. | PVC′: 120 μm | PVC′: 120 μm | Dimensional stability %: | WVTR (38° C. % 90% Rh) |
| | PVDC: 100 gsm | PVDC: 100 gsm | Longitudinal: −2.5 | gm/m²/day: 0.07 |
| | | | Transverse: +1 | |
| | | | Tensile strength kg/cm2 | |
| | | | MD: 404 | |
| | | | TD: 411 | |
| | | | Impact strength gsm: 680 | |
| | | | WVTR (38° C. 90% Rh) | |
| | | | gm/m²/day: 0.0640 | |
| 7. | PVC*: 130 μm | PVC*: 120 μm | Impact strength gsm: 400 | WVTR (38° C. % 90% Rh) |
| | PE: 25 μm | PVDC: 60 gsm | WVTR (38° C. 90% Rh) | gm/m²/day: 0.4357 |
| | PVDC: 80 gsm | | gm/m²/day: 0.08 | |
| 8. | PVC′: 130 μm | PVC′: 120 μm | Impact strength gsm: 420 | WVTR (38° C. % 90% Rh) |
| | PE: 25 μm | PVDC: 60 gsm | WVTR (38° C. 90% Rh) | gm/m²/day: 0.4201 |
| | PVDC: 80 gsm | | gm/m²/day: 0.07 | |
| 9. | PVC⁺: 130 μm | PVC⁺: 120 μm | Impact strength gsm: 440 | WVTR (38° C. % 90% Rh) |
| | PE: 25 μm | PVDC: 60 gsm | WVTR (38° C. 90% Rh) | gm/m²/day: 0.4369 |
| | PVDC: 80 gsm | | gm/m²/day: 0.083 | |
| 10. | PVC⁺⁺: 130 μm | PVC⁺⁺: 120 μm | Impact strength gsm: 410 | WVTR (38° C. % 90% Rh) |
| | PE: 25 μm | PVDC: 60 gsm | WVTR (38° C. 90% Rh) | gm/m²/day: 0.4402 |
| | PVDC: 80 gsm | | gm/m²/day: 0.0824 | |
| 11. | PVC⁺⁺⁺: 130 μm | PVC⁺⁺⁺: 120 μm | Impact strength gsm: 410 | WVTR (38° C. % 90% Rh) |
| | PE: 25 μm | PVDC: 60 gsm | WVTR (38° C. 90% Rh) | gm/m²/day: 0.4368 |
| | PVDC: 80 gsm | | gm/m²/day: 0.0807 | |
| 12. | PVC**: 130 μm | PVC**: 120 μm | Impact strength gsm: 470 | WVTR (38° C. % 90% Rh) |
| | PE: 25 μm | PVDC: 60 gsm | WVTR (38° C. 90% Rh) | gm/m²/day: 0.4401 |
| | PVDC: 80 gsm | | gm/m²/day: 0.0802 | |
| 13. | PVC^{#}*: 130 μm | PVC^{#}*: 120 μm | Impact strength gsm: 490 | WVTR (38° C. % 90% Rh) |
| | PE: 25 μm | PVDC: 60 gsm | WVTR (38° C. 90% Rh) | gm/m²/day: 0.4300 |
| | PVDC: 80 gsm | | gm/m²/day: 0.0812 | |
| 14. | PVC*: 130 μm | PVC*: 120 μm | Impact strength gsm: 410 | WVTR (38° C. % 90% Rh) |
| | PE: 25 μm | PVDC: 60 gsm | WVTR (38° C. 90% Rh) | gm/m²/day: 0.4483 |
| | PVDC: 60 gsm | | gm/m²/day: 0.11 | |
| 15. | PVC′: 130 μm | PVC′: 120 μm | Impact strength gsm: 400 | WVTR (38° C. % 90% Rh) |
| | PE: 25 μm | PVDC: 60 gsm | WVTR (38° C. 90% Rh) | gm/m²/day: 0.4354 |
| | PVDC: 60 gsm | | gm/m²/day: 0.105 | |
| 16. | PVC⁺⁺: 130 μm | PVC*: 120 μm | Impact strength gsm: 400 | WVTR (38° C. % 90% Rh) |
| | PE: 25 μm | PVDC: 60 gsm | WVTR (38° C. 90% Rh) | gm/m²/day: 0.4577 |
| | PVDC: 60 gsm | | gm/m²/day: 0.113 | |
| 17. | PVC⁺: 130 μm | PVC⁺: 120 μm | Impact strength gsm: 400 | WVTR (38° C. % 90% Rh) |
| | PE: 25 μm | PVDC: 60 gsm | WVTR (38° C. 90% Rh) | gm/m²/day: 0.4471 |
| | PVDC: 60 gsm | | gm/m²/day: 0.113 | |
| 18. | PVC⁺⁺⁺: 130 μm | PVC⁺⁺⁺: 120 μm | Impact strength gsm: 400 | WVTR (38° C. % 90% Rh) |
| | PE: 25 μm | PVDC: 60 gsm | WVTR (38° C. 90% Rh) | gm/m²/day: 0.4409 |
| | PVDC: 60 gsm | | gm/m²/day: 0.112 | |
| 19. | PVC**: 130 μm | PVC**: 120 μm | Impact strength gsm: 440 | WVTR (38° C. % 90% Rh) |
| | PE: 25 μm | PVDC: 60 gsm | WVTR (38° C. 90% Rh) | gm/m²/day: 0.4403 |
| | PVDC: 60 gsm | | gm/m²/day: 0.111 | |
| 20. | PVC^{#}*: 130 μm | PVC^{#}*: 120 μm | Impact strength gsm: 430 | WVTR (38° C. % 90% Rh) |
| | PE: 25 μm | PVDC: 60 gsm | WVTR (38° C. 90% Rh) | gm/m²/day: 0.4419 |
| | PVDC: 60 gsm | | gm/m²/day: 0.107 | |
| 21. | PVC*: 130 μm | PVC*: 120 μm | Impact strength gsm: 390 | WVTR (38° C. % 90% Rh) |
| | PE: 25 μm | PVDC: 80 gsm | WVTR (38° C. 90% Rh) | gm/m²/day: 0.3958 |
| | PVDC: 120 gsm | | gm/m²/day: 0.053 | |
| 22. | PVC′: 130 μm | PVC′: 120 μm | Impact strength gsm: 430 | WVTR (38° C. % 90% Rh) |
| | PE: 25 μm | PVDC: 80 gsm | WVTR (38° C. 90% Rh) | gm/m²/day: 0.3876 |
| | PVDC: 120 gsm | | gm/m²/day: 0.05 | |
| 23. | PVC⁺: 130 μm | PVC⁺: 120 μm | Impact strength gsm: 410 | WVTR(38° C. % 90% Rh) |
| | PE: 25 μm | PVDC: 80 gsm | WVTR (38° C. 90% Rh) | gm/m²/day: 0.3905 |
| | PVDC: 120 gsm | | gm/m²/day: 0.0538 | |
| 24. | PVC⁺⁺: 130 μm | PVC⁺⁺: 120 μm | Impact strength gsm: 410 | WVTR (38° C. % 90% Rh) |
| | PE: 25 μm | PVDC: 80 gsm | WVTR (38° C. 90% Rh) | gm/m²/day: 0.3908 |
| | PVDC: 120 gsm | | gm/m²/day: 0.054 | |
| 25. | PVC⁺⁺⁺: 130 μm | PVC*: 120 μm | Impact strength gsm: 450 | WVTR (38° C. % 90% Rh) |
| | PE: 25 μm | PVDC: 80 gsm | WVTR (38° C. 90% Rh) | gm/m²/day: 0.3905 |
| | PVDC: 120 gsm | | gm/m²/day: 0.0532 | |
| 26. | PVC**: 130 μm | PVC**: 120 μm | Impact strength gsm: 410 | WVTR (38° C. % 90% Rh) |
| | PE: 25 μm | PVDC: 80 gsm | WVTR (38° C. 90% Rh) | gm/m²/day: 0.3901 |
| | PVDC: 120 gsm | | gm/m²/day: 0.0531 | |
| 27. | PVC^{#}*: 130 μm | PVC^{#}*: 120 μm | Impact strength gsm: 420 | WVTR (38° C. % 90% Rh) |
| | PE: 25 μm | PVDC: 80 gsm | WVTR (38° C. 90% Rh) | gm/m²/day: 0.3905 |
| | PVDC: 120 gsm | | gm/m²/day: 0.0502 | |
| 28. | PVC′: 130 μm | PVC′: 120 μm | Impact strength gsm: 400 | WVTR (38° C. % 90% Rh) |
| | PE: 25 μm | PVDC: 80 gsm | WVTR (38° C. 90% Rh) | gm/m²/day: 0.4121 |
| | PVDC: 80 gsm | | gm/m²/day: 0.06 | |
| 29. | PVC⁺: 130 μm | PVC⁺: 120 μm | Impact strength gsm: 500 | WVTR (38° C. % 90% Rh) |
| | PE: 25 μm | PVDC: 80 gsm | WVTR (38° C. 90% Rh) | gm/m²/day: 0.4296 |
| | PVDC: 80 gsm | | gm/m²/day: 0.0649 | |
| 30. | PVC⁺⁺: 130 μm | PVC⁺⁺: 120 μm | Impact strength gsm: 400 | WVTR (38° C. % 90% Rh) |
| | PE: 25 μm | PVDC: 80 gsm | WVTR (38° C. 90% Rh) | gm/m²/day: 0.4320 |
| | PVDC: 80 gsm | | gm/m²/day: 0.0652 | |
| 31. | PVC⁺⁺⁺: 130 μm | PVC*: 120 μm | Impact strength gsm: 400 | WVTR (38° C. % 90% Rh) |
| | PE: 25 μm | PVDC: 80 gsm | WVTR (38° C. 90% Rh) | gm/m²/day: 0.4231 |
| | PVDC: 80 gsm | | gm/m²/day: 0.0637 | |
| 32. | PVC**: 130 μm | PVC**: 120 μm | Impact strength gsm: 450 | WVTR (38° C. % 90% Rh) |
| | PE: 25 μm | PVDC: 80 gsm | WVTR (38° C. 90% Rh) | gm/m²/day: 0.3997 |
| | PVDC: 80 gsm | | gm/m²/day: 0.0640 | |
| 33. | PVC^{#}*: 130 μm | PVC*: 120 μm | Impact strength gsm: 450 | WVTR (38° C. % 90% Rh) |
| | PE: 25 μm | PVDC: 80 gsm | WVTR (38° C. 90% Rh) | gm/m²/day: 0.4277 |
| | PVDC: 80 gsm | | gm/m²/day: 0.0642 | |

*= glass clear PVC;
′= white opaque PVC;
⁺= Amber PVC;
⁺⁺= Red PVC;
⁺⁺⁺= Green PVC;
**= clear PVC with UV additive;
^{#}*= Yellow PVC with UV additive;
MD: longitudinal direction; TD: transverse direction and μm = gsm/1.65.

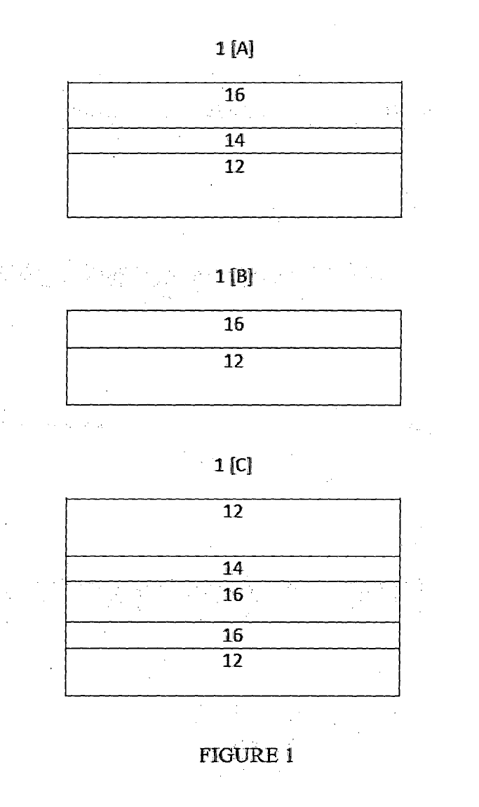

The films prepared as per above examples are illustrated in the accompanying drawings. FIG. 1 illustrates multi-layer formable film [1C] prepared in accordance with the example 1 which contains five layers namely, PVC (12), PE (14), PVDC (16), PVDC (16) and PVC (12). The film is obtained by laminating the substrate layer represented by 1[A] which contains PVC (12), PE (14) and PVDC (16); and the base layer represented by 1[B] which contains PVC (12) and PVDC (16).

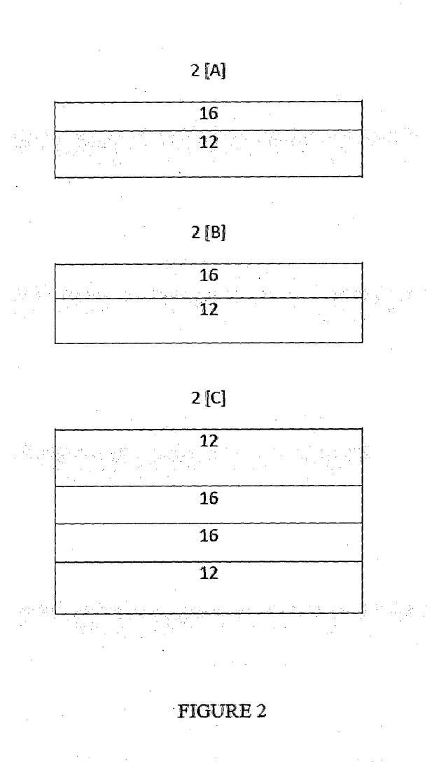

FIG. 2 illustrates multi-layer formable film [2C] prepared in accordance with example 7 which contains four layers namely, PVC (12), PVDC (16), PVDC (16) and PVC (12). The film is obtained by laminating the substrate layer represented by 2[A] which contains PVC (12) and PVDC (16); and the base layer represented by 2[B] which contains PVC (12) and PVDC (16).

The embodiments herein and the various features and advantageous details thereof are explained with reference to the non-limiting embodiments in the description. Descriptions of well-known components and processing techniques are omitted so as to not unnecessarily obscure the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A multilayer formable barrier film having a thickness ranging from 100 to 750 micron comprising:
i. a substrate layer having a thickness ranging from 50 to 500 micron, said substrate layer comprises: i) a polyvinyl chloride (PVC) film having a thickness ranging from 50 to 200, optionally laminated with a polyethylene (PE) film having a thickness ranging from 10 to 100 and ii) at least one poly(vinylidene dichloride)(PVDC) layer having a thickness ranging from 10 to 100 micron; and
ii. a base layer having a thickness ranging from 50 to 250 micron laminated to said substrate layer through an adhesive coat, said base layer comprises i) a polyvinyl chloride (PVC) film having a thickness ranging from 50 to 200, optionally laminated with a polyethylene (PE) film having a thickness ranging from 10 to 100 and ii) at least one poly(vinylidene dichloride)(PVDC) layer having a thickness ranging from 10 to 100 micron.

2. The film as claimed in claim 1, wherein said poly(vinylidene dichloride) (PVDC) is selected from the group consisting of regular poly(vinylidene dichloride) (RPPVDC), high barrier poly(vinylidene dichloride) (SBPVDC) and combinations thereof.

3. The film as claimed in claim 1, characterized in that said film exhibits at least one barrier property selected from the group consisting of moisture barrier, oxygen barrier, gas barrier and vapor barrier properties.

4. The film as claimed in claim 1, wherein the adhesive is selected from the group consisting of polyurethane, acrylic polymer, isocyanides and combinations thereof.

5. The film as claimed in claim 1, characterized by WVTR ranging from 0.01 to 0.5 gm/m²/day, preferably from 0.04 to 0.15 gm/m²/day.

6. A blister package comprising a lid element and a base element sealing securely to each other, said base element is made from the multilayer formable barrier film of claim 1, said base element comprises a flat portion and a formed portion.

7. The blister package as claimed in claim 6, wherein the WVTR of the formed portion ranging from 0.02 to 0.5 gm/m²/day.

8. A process for the preparation of a multilayer formable barrier film having a thickness in the range of 100 to 750 micron; said process comprises the following steps:
providing a substrate layer of thickness 50 to 500 micron by coating a polyvinyl chloride (PVC) film of thickness ranging from 50 to 200 with at least one layer of poly(vinylidene dichloride)(PVDC) of thickness ranging from 10 to 100 micron using an adhesive coat having a thickness ranging from 0.1 to 10 micron,
obtaining a base layer of thickness 50 to 250 micron by coating a (polyvinyl chloride) PVC film of thickness ranging from 50 to 200 with at least one layer of poly(vinylidene dichloride)(PVDC) of thickness ranging from 10 to 100 micron using an adhesive coat having a thickness ranging from 0.1 to 10 micron, and
laminating said substrate layer and said base layer using an adhesive coat having a thickness ranging from 0.1 to 10 micron multilayer formable barrier film.

9. The process as claimed in claim 1, wherein the process includes a step of laminating the polyvinyl chloride (PVC) film with a polyethylene (PE) film using an adhesive coat before coating said PVC film with the PVDC layer.

10. The process as claimed in claim 1, wherein said poly(vinylidene dichloride) (PVDC) is selected from the group consisting of regular poly(vinylidene dichloride) (RPPVDC), high barrier poly(vinylidene dichloride) (SBPVDC) and combinations thereof; and the adhesive is selected from the group consisting of polyurethane, acrylic polymer, isocyanides and combinations thereof.
